(19) United States
(12) Patent Application Publication
(10) Pub. No.: US 2016/0006701 A1
(43) Pub. Date: Jan. 7, 2016

(54) METHOD OF AND A DEVICE HANDLING CHARGING DATA IN AN IP-BASED NETWORK

(71) Applicant: TELEFONAKTIEBOLAGET L M ERICSSON (publ), Stockholm (SE)

(72) Inventor: Rogier August Caspar Joseph NOLDUS, BM Goirle (NL)

(73) Assignee: Telefonaktiebolaget LM Ericsson (publ), Stockholm (SE)

(21) Appl. No.: 14/770,673

(22) PCT Filed: Apr. 3, 2013
(86) PCT No.: PCT/EP2013/057023

§ 371 Date: Aug. 26, 2015

(51) Int. Cl. H04L 29/06; H04L 29/08

(52) U.S. Cl. CPC H04L 63/0428; H04L 67/28

(57) ABSTRACT

The invention relates to a method of handling charging data in a first network entity of an IP-based network. The first network entity receives an IP communication control message comprising user identification data and an associated encryption key. Charging data associated with a communications activity related to said user identification data is encrypted using the encryption key and combined with the user identification data to obtain a charging record with encrypted charging data which charging record is transmitted to a second network entity having the role of charging gateway function. The second network entity receives the charging record with encrypted charging data and subjects the encrypted charging data to a decryption process to obtain a charging record comprising the user identification data and unencrypted charging data.

### TECHNICAL FIELD

The invention relates to the field of network technologies, and in particular, to a method of and a device handling charging data in an IP-based network, more particularly, to an IMS based communication network.

### BACKGROUND

When a subscriber of an IMS (IP Multimedia Subsystem) communication services network establishes a communication session or uses the network for a stand-alone transaction such as an Instant Message, one or more charging records are generated by various entities in the network.

FIG. 1 shows a rudimentary overview of such a network and the entities generating charging records. The lines in FIG. 1 between the various functional entities represent reference points that carry SIP (Session Initiation Protocol) signalling or GSM/3G network messages. An IMS based communication service comprises exchange of SIP signalling between the various entities in the network.

FIG. 1 shows an SCC-AS (Session Centralization and Continuity-Application Server), an MMTel-AS (Multi Media Telephony-Application Server) and an IP-SM-Gw (Internet Protocol-Short Message-Gateway) as application servers. The application servers facilitate particular communication services. Other communication services running on application servers may be present in an IMS network.

A brief recap of the generation of charging records for an IMS communication service is the following:
a network entity acting as P-CSCF (Proxy-Call Session Control Function) generates charging records that contain specifically access network related information and also general SIP signalling related information.
a network entity acting as S-CSCF (Serving-Call Session Control Function) generates charging records generally related to communication session establishment (‘communication connectivity’),
a network entity acting as I-CSCF (Interrogating-Call Session Control Function) generates charging records for termination call establishment or for unregistered originating call establishment,
a network entity acting as SIP-AS (Session Initiation Protocol-Application

Server) which might be an SCC-AS, MMTel-AS, IP-SM-Gw or any other application server facilitating particular communication services, may generate charging records for the respective communication service,
a network entity acting as eMSC (enhanced Mobile Switching Center) generates charging records that are established from CS (Circuit Switched) devices that are connected to the IMS network through the eMSC.

It should be noted that when a subscriber is registered through multiple devices, there will be multiple (logical) P-CSCFs for the subscriber. Furthermore, all IMS based communication services are handled by the S-CSCF in the network allocated to the subscriber. An operator may decide not to generate charging records from I-CSCF. Other entities in an IMS network not shown in FIG. 1 also have the ability to generate charging records.

Charging records are stored as text files in the respective system node or network entity. The charging records are transferred to a CGF (Charging Gateway Function. The charging records may be sent to CGF via a CDF (Charging Data Function). The CDF is not depicted in FIG. 1.

So long as charging records are stored and transferred as text files in the network, a security risk exists, as O&M (Operation and Management) personnel can read charging records from network nodes. Especially for a designated class of users of the network, e.g. army officers above a certain security classification and national agency personnel, this forms a security risk. Charging records contain information that should not be available to unauthorized persons. Said class of users demands that O&M personnel does not have access to charging records.

Considering the fact that IP-based networks such as IMS based network will be used increasingly for multimedia communication, any risk regarding the storing and transferring of charging records needs to be mitigated.

### SUMMARY

It is an object of the invention to provide methods and devices for increasing the security level of the charging records that are generated within the respective entities of an IP-based communication network, more particularly an IMS based communication network.

According to a first aspect of the invention, there is provided a method of handling charging data in a first network entity of an IP-based network and a method of handling charging data in a second network entity of the IP-based network. The first network entity receives an IP communication control message comprising user identification data and an associated encryption key. The first network entity generates charging data associated with a communications activity related to said user identification data and encrypts the charging data using the encryption key to obtain encrypted charging data. The first network entity processes the user identification data and the encrypted charging data to obtain a charging record with encrypted charging data. The first network entity could temporarily store the charging record with encrypted charging data in a data storage prior to transmission to the second network entity having the role of charging gateway function. The second network entity having the role of charging gateway function receives the charging record comprising the user identification data and the encrypted charging data and subjects the charging record comprising user identification data and encrypted charging data to a decryption process to obtain a charging record comprising the user identification data and unencrypted charging data.

The principle of the present invention is that entities in the IP-based network, including communication services enablers, use individually secured and protected charging record storage and transportation for subscribers. A network entity generating charging data receives for a subscriber next to subscriber data identifying the subscriber in the network, an encryption key assigned to the subscriber. The encryption of the charging data makes the charging data ‘unreadable’ for regular O&M personnel, as they don't have access to the decryption key. The charging records follow the regular stream through the IP-based network, towards the network entity having the role of charging gateway function (CGF). The CGF is formed by a limited number of nodes in the network, i.e. the CGF has the role of concentrator. In the CGF, the charging records are decrypted and processed further in the network, as normal.

In this manner, charging records may be generated by large number of nodes/entities in the network, may be stored in these nodes and transported through the network. Up to the point where the charging records need to be processed (or where the first steps of processing are taken), i.e. in the charging gateway function, there is no need for the charging data to be readable as plain text. Hence, the charging data may be protected up to that point.

The method mitigates the risk formed by charging records stored in various places in the network and transported between various nodes. The method enables that charging records are in readable form in a small number of nodes in the network.

In an embodiment of the method in the first network entity, the processing action includes encrypting the user identification data using a network encryption key. In an alternative embodiment, the processing action further includes encrypting the user identification data and the encrypted charging data using a network encryption key. These features mitigate the risk formed by charging records stored in various places in the network further.

In an embodiment, the first network entity sends another IP communication control message to another network entity, the another IP communication control message comprising the user identification data and the associated encryption key. This feature provides a simple mechanism to provide the encryption key associated with a subscriber to other network entities. There is no need to request a user identification data provisioning system in the network to provide a message which includes the encryption key to the other network entities.

In an embodiment, the second network entity which has the role of charging gateway function transmits the charging record comprising the user identification data and the encrypted charging data to a network entity performing the decryption process. Subsequently, the second network entity receives the charging record comprising the user identification data and unencrypted charging data from the network entity performing the decryption process for further processing in the network. In this embodiment, the decryption key is not transferred to the second network entity, reducing the risk that an operator of the second network entity could obtain the decryption key and could use the decryption key to decrypt charging records at the first network entity.

In an alternative embodiment, the second network entity receives a charging system provisioning message comprising user identification data and an associated decryption key. The second network entity decrypts the received encrypted charging data by using the decryption key associated with the user identification data to obtain the unencrypted charging data. Subsequently, the second network system combines the user identification data and the unencrypted charging data to obtain a charging record comprising the user identification data and unencrypted charging data suitable for further processing in the network in a normal way.

In an embodiment, the decryption key associated with the user identification data differs from the encryption key associated with the user identification data. This feature further reduces the risk of unauthorized access to the charging data.

In an embodiment, the IP-based network is an IMS network and the IP communication control messages are SIP messages. IMS has a very secure mechanism for transporting information between network nodes. That mechanism is used to convey a subscriber-specific set of charging record encryption keys from a Home Subscriber Server (HSS) to the respective entities in the IMS network, whereby communication between HSS and S-CSCF uses Diameter as message protocol. SIP signalling between User Equipment (UE) and P-CSCF is protected through the use of a Security Association (SA). The SA is established between UE and P-CSCF during registration. The SA is based on subscriber-specific credentials that are transferred from HSS to P-CSCF. The SA credentials are not readable by the operator, through administrative commands. Likewise, subscriber-specific credentials may be used to protect the charging records that are generated by P-CSCF or S-CSCF. The subscriber-specific credentials are transferred through SIP signalling, during registration, but are not be readable by the operator, through administrative commands. The charging provisioning message might be a Lightweight Directory Access Protocol (LDAP) message or a Common Air Interface 3G (CAI3G) message.

According to a second aspect, there is provided a processing device comprising a processor, an Input/Output device to connect to the network system, a database and a data storage comprising instructions, which when executed by the processor, cause the processing device to receive an IP communication control message comprising user identification data and an associated encryption key and store the user identification data and associated encryption key in the database; to obtain charging data associated with a communication activity related to said user identification data; to subject the charging data to encryption by using an encryption key which is associated with the user identification data to obtain encrypted charging data; to process the user identification data and the encrypted charging data to obtain a charging record with encrypted charging data; and to transmit the charging record with encrypted charging data to a network entity having the role of a charging gateway function.

According to a third aspect, there is provided a processing device comprising a processor, an Input/Output device to connect to the network system, a database and a data storage comprising instructions, which when executed by the processor, cause the processing device to receive a charging record comprising user identification data and encrypted charging data, the encrypted charging data has been obtained by subjecting charging data associated with a communication activity related to the user identification data to encryption by using an encryption key which is associated with the user identification data; and to subject the charging record comprising the user identification data and the encrypted charging data to a decryption process to obtain a charging record with the user identification data and unencrypted charging data. In a further embodiment, the instructions, which when executed by the processor (1210), further cause the processing device to receive a charging system provisioning message comprising user identification data and an associated decryption key. The subject action comprises decrypting the encrypted charging data by using the decryption key associated with the user identification data to obtain unencrypted charging data; and combining the user identification data and the unencrypted charging data to obtain the charging record with the user identification data and unencrypted charging data.

Other features and advantages will become apparent from the following detailed description, taken in conjunction with the accompanying drawings which illustrate, by way of example, various features of embodiments.

### BRIEF DESCRIPTION OF THE DRAWINGS

These and other aspects, properties and advantages will be explained hereinafter based on the following description with reference to the drawings, wherein like reference numerals denote like or comparable parts, and in which:

FIG. 1 is a block diagram showing schematically the transfer of charging records for IMS based communication services;

FIG. 2 shows the transfer of the encryption key from HSS to P-CSCF;

FIG. 3 shows the transfer of the encryption key from P-CSCF to AS;

FIG. 4 shows the transfer of the encryption key from HSS via I-CSCF;

FIG. 5 illustrates a first embodiment of enabling encryption and decryption of charging records in a network;

FIGS. 6-8 illustrate three embodiments of an encrypted charging record;

FIG. 9 illustrates a second embodiment of enabling encryption and decryption of charging records in a network;

FIG. 10 is a flow diagram illustrating actions that are carried out on a network entity generating charging records;

FIGS. 11-12 are flow diagrams illustrating actions that are carried out on a network entity acting a charging gateway function; and,

FIG. 13 is a block diagram illustrating a processing unit.

### DETAILED DESCRIPTION

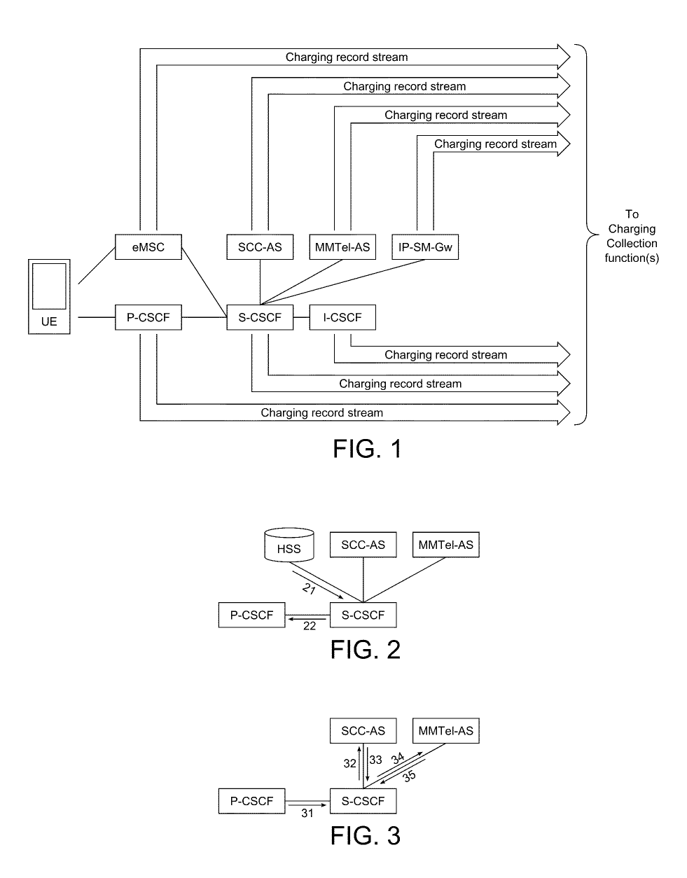

To enable network entities in an IP Multimedia Core Network Subsystem (IMS) based communications service network as shown in FIG. 1 to generate charging data which is protected by encryption, those entities need to receive a charging data encryption key.

The charging record encryption keys for the subscribers are stored in the Home Subscriber Server (HSS), per subscriber, as part of the non-transparent IMS subscription data. The encryption would typically have a length between 32 bit and 64 bit (too long encryption is not allowed in certain countries). Rationale of storing the charging data encryption key associated with a subscriber in HSS is:
(i) HSS is the permanent repository for IMS subscription data;
(ii) The charging data encryption key needs to be conveyed through the network; the transfer of subscriber data through the network starts from HSS.

The charging data encryption key may be consistent per subscriber, i.e. it does not have to change over time. However, if the charging data encryption key changes over time, the charging data decryption key to enable decryption of the charging data which has been encrypted with a previously used charging data encryption key has to be kept in the HSS for a predefined time period after replacement of the previously used charging data encryption key with a new charging data encryption key.

Whereas a subscriber's IMS subscription profile may comprise multiple IP Multimedia Private Identities (IMPIs) and multiple IP Multimedia Public Identities (IMPUs), linked through one or more Implicit Registration Sets (IRS), a subscriber would need a single charging data encryption key only.

As an implementation option, the charging data encryption key may be writable to HSS, but not readable (through an operator command) from HSS.

The charging data encryption key is a separate data item, as opposed to re-using an existing security related data item, such as:
(1) Authentication key, e.g. the authentication key for IMS authentication that's contained in an HSS or in an Authentication Center (AuC); the authentication key for IMS authentication (and other authentication keys) are to be kept in HSS or AuC and shall not be transferred between nodes. For the authentication key for Circuit Switched (CS)/Packet System (PS)/Evolved Packet System (EPS) access, there is the additional reason that the method shall not depend on particular form of access, i.e. should not be directed to Universal Terrestrial Radio Access Network (UTRAN) or Long-Term Evolution (LTE) access. The method is usable for wireless local area network (WLAN) access, for example, as well.
(2) Security Association (SA) parameters that are used for establishing the security association between User Equipment (UE) and Proxy-Call Session Control Function (P-CSCF). The SA parameters are not constant over time, so are not suitable for the purpose of encryption/decryption as the decryption key needs to be securely stored over a predefined period somewhere in the network.

The charging data encryption key needs to be securely transported from HSS to the network entities acting as Serving-Call Session Control Function (S-CSCF), P-CSCF, Multi Media Telephony-Application Server (MMTel-AS), Session Centralization and Continuity-Application Server (SCC-AS), and other Session Initiation Protocol-Application Servers (SIP-AS)'s (not shown in FIG. 2) as appropriate, and Interrogating-Call Session Control Function (I-CSCF).

FIG. 2 depicts the transfer of the charging data encryption key from HSS to P-CSCF. During registration, the HSS transfers the address(es) of the charging function(s), to S-CSCF, indicated with reference 21. The S-CSCF transfers these address(es) to P-CSCF. The charging functions are the nodes (or functional entity) to which charging records, generated for a multimedia session to/from this subscriber, shall be sent. The charging functions addresses are transferred, through SIP signalling, in the P-charging-function-addresses (PCFA) header. The P-CSCF stores the PCFA header, received during registration, and uses it for the dispatching of charging records for this subscriber. The P-CSCF also includes the PCFA header in originating initial SIP request, such as Invite.

The PCFA according to the present 3GPP TS 32.229 standard is augmented with the charging data encryption key. In that manner, the P-CSCF receives a combination of:
address(es) of the charging entity to which the charging records for this subscriber shall be sent; and,
encryption key, to be used for encrypting the charging data for this subscriber.

Arrow with reference 21 is the transfer of the charging data encryption key from the HSS to the S-CSCF, in existing Server assignment answer (SAA) Diameter message. The SAA is used to transfer user subscription information to S-CSCF, including the charging function address(es). Arrow with reference 22 is the transfer of the charging data encryption key from S-CSCF to P-CSCF. The S-CSCF places the charging function address(es) in PCFA header and transmits the PCFA header to P-CSCF.

As mentioned, the P-CSCF includes PCFA header in originating initial SIP requests. According to the present application, the PCFA header will include the charging data encryption key. So, the charging data encryption key is transparently and securely conveyed to other entities in the SIP chain that may generate charging records. This includes (non-exhaustive) S-CSCF, SCC-AS and MMTel-AS, IP-SM-Gw. FIG. 3 shows the transfer of the charging data encryption key from P-CSCF via a SIP chain indicated by 31-35, to application servers.

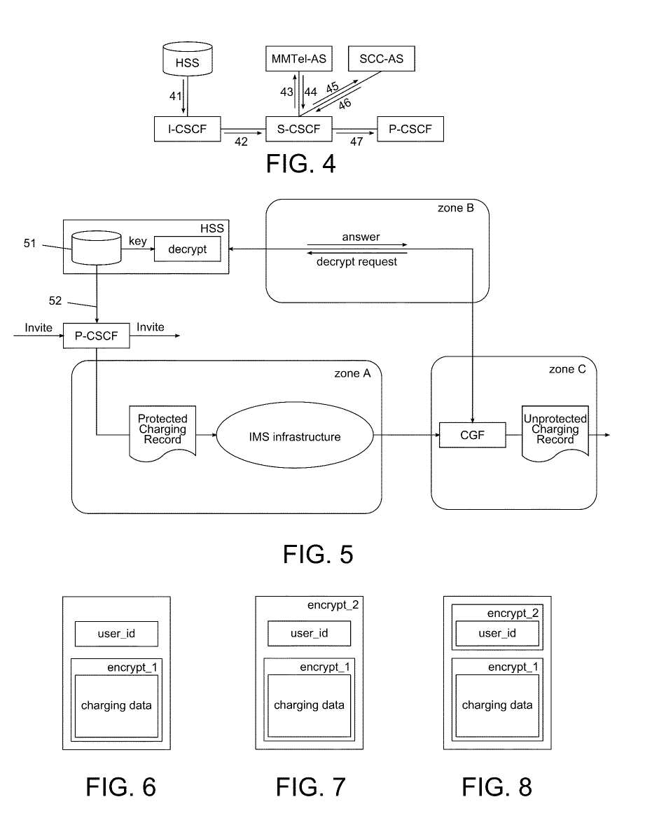

FIG. 4 shows the transfer of the charging data encryption key from HSS via I-CSCF. According to the present application, the HSS is enhanced as follows. During terminating initial SIP request 41, the HSS transfers the charging data encryption key to I-CSCF, in the Location information answer (LIA) Diameter message. I-CSCF will, based in information received in LIA, transfer the initial SIP request to an S-CSCF. I-CSCF includes the encryption key in the PCFA header and includes the PCFA header in the initial SIP request 42 that is sent to S-CSCF. Again, the charging data encryption key can now be transparently conveyed to (non-exhaustive) S-CSCF, IP-SM-Gw, MMTel-AS, SCC-AS and P CSCF via SIP chain 43-47. Each of these network entities can now apply the required encryption on the charging data that is generated for this subscriber.

It be emphasized that the PCFA in the initial request from I-CSCF to S-CSCF does not need to contain the address(es) of the charging function to which the charging records for this subscriber shall be sent. According to current art, HSS does not convey the charging function address(es) for the served subscriber, to I CSCF. The method according to the present application would therefore entail that I-CSCF includes PCFA header in the initial SIP request, with the PCFA header containing the charging data encryption key, but not the charging function address(es). I-CSCF sends the charging record to the charging function of which it has determined the address as per prior art, e.g. through node configuration.

The Charging-Information Attribute value pair (AVP) that's used to convey the charging function addresses from HSS to S-CSCF is defined as follows (3GPP TS 32.229 [3]):

```
AVP format
Charging-Information :: = < AVP Header : 618 10415 >
      [ Primary-Event-Charging-Function-Name ]
      [ Secondary-Event-Charging-Function-Name ]
      [ Primary-Charging-Collection-Function-Name ]
      [ Secondary-Charging-Collection-Function-Name ]
      *[ AVP ]
```

The *[AVP] notation allows for extending the Charging-Information AVP. The following element could be added, for example:
Charging-data-encryption-key

The charging data encryption key comprises a bit string of defined length.

The S-CSCF copies the charging record encryption key, received from HSS, from Diameter SAA into the P-charging-function-addresses (PCFA) in the 200 Ok SIP response towards P-CSCF. The PCFA is defined in IETF RFC 3455 [1]:

| | |
|---|---|
| P-Charging-Addr | = “P-Charging-Function-Addresses” HCOLON |
| | charge-addr-params |
| | *(SEMI charge-addr-params) |
| charge-addr-params | = ccf / ecf / generic-param |

| | |
|---|---|
| ccf | = “ccf” EQUAL gen-value |
| ecf | = “ecf” EQUAL gen-value |

The notation *(SEMI charge-addr-params) allows for including additional parameters in the P-Charging-Addr header, e.g. the charging data encryption key.

For terminating initial SIP request, it's the I-CSCF that will receive the charging data encryption key from HSS. And hence, the I-CSCF will then copy the charging data encryption key into the PCFA header in SIP.

Generally, the present application uses the existing methodology of transferring the charging function address between SIP proxies, whereby the charging function address is received from HSS. The charging function address is extended with the charging data encryption key.

FIG. 5 illustrates a first embodiment of a method enabling encryption and decryption of charging records in an IP-based network. The HSS comprises a data storage 51 for storing the charging data encryption key and charging data decryption key. Depending on the encryption method used, the charging data encryption key and decryption key are similar or different. The encryption and decryption key could be generated internally in the HSS or externally wherein the encryption and decryption key are transmitted and stored in the respective locations in the data storage 51. Reference 52 indicates the secure transfer of the charging data encryption key from HSS to P-CSCF via SIP messages as described before.

The charging data is encrypted (by P-CSCF in this example) using the charging data encryption key that was received for this subscriber from the HSS. When the charging data is encrypted, there needs to be an information element available from the charging record based on which the decryption of the charging data can be done. Put differently, when the network entity doing the encryption uses encryption key of subscriber X, the entity doing the decryption of this charging record needs to know that the charging data was encrypted with encryption key of subscriber X. The information element that may be used for this purpose is IMS public user identity (IMPU) or IMS private user identity (IMPI). Rationale is that IMPU and IMPI are unique identifiers of a subscriber of an IMS network.

Three embodiments of an encrypted charging record are described to convey the IMPU or IMPI and charging data, in a charging record.

The first embodiment of an encrypted charging record is shown in FIG. 6. In the context of the present application an encrypted charging record is a charging record wherein at least the charging data is encrypted by using a user specific charging data encryption key. A charging record contains two information parts (i) user identification data and (ii) charging data. In this embodiment the user identification data defined by IMPU or IMPU is not encrypted, but are visible in the charging record. The charging data itself is encrypted with the user-specific charging data encryption key associated with the user identification data. The combination of user identification data and encrypted charging data forms the encrypted charging record.

FIG. 7 shows a second embodiment of an encrypted charging record. In this embodiment, the charging data is encrypted based on the user-specific charging data encryption key which is associated with the IMPU/IMPI. The IMPU/IMPI are not encrypted by the charging data encryption key. The combination of user identification data and encrypted charging data is, as a next step, encrypted using a network encryption key to obtain the encrypted charging record.

The network encryption key is an encryption key that is used globally in the operator's IMS network for secure storage and transfer of charging records. By encrypting the ‘charging record as a whole’, it is prevented that the IMPU/IMPI in the charging record is visible/readable in the secure storage and transfer. However, the network encryption key is configured in the nodes that generate charging records and in the nodes that receive charging records. Typically, the CGF can hence determine the IMPU/IMPI of the charging record, but intermediate entities can't.

FIG. 8 shows a third embodiment of an encrypted charging record. In this embodiment the network encryption is applied on the IMPU/IMPI alone, as opposed to applying the network encryption on the entire charging record as in the embodiment in FIG. 7. Rationale of this alternative is that the charging data itself is already encrypted. With this alternative method, charging data and IMPU/IMPI are adequately protected. In this embodiment the network encrypted user identification data and encrypted charging data are combined to obtain the encrypted charging record.

In a fourth embodiment of an encrypted charging, the charging data is encrypted based on the user-specific charging data encryption key which is associated with the IMPU/IMPI. The IMPU/IMPI are not encrypted by the user-specific charging data encryption key. In a next step, the user identification data and the encrypted charging data are encrypted as individual parts using the network encryption key and subsequently combined to obtain the encrypted charging record.

Referring to FIG. 5, encrypted charging records are transferred via Diameter messages, from (i) entity generating the charging records to (ii) entity receiving the charging records. In FIG. 5 the entity generating the charging record is P-CSCF and the network entity receiving the charging record is CGF. The transfer of charging records occurs within a zone referred to as ‘Zone A’ over the IMS infrastructure. Within Zone A, unencrypted charging records can be read by maintenance personnel. It is within Zone A that the invention provides protection of charging data.

The Charging gateway function (CGF) is considered to reside in a zone referred to as Zone C. Tighter security applies to zone C. Access to nodes and functional entities within Zone C shall be restricted to authorized personnel (e.g. password protected access to data in nodes).

The CGF receives an encrypted charging record according to one of the four embodiments described in the present application. If a network encryption key is used to encrypt only the user identification data (IMPU/IMPI), the CGF uses the network encryption key for decrypting the user identification data (IMPU/IMPI) of the encrypted charging record. If the network encryption key is used to encrypt the user identification data and the encrypted charging data, the CGF uses the network encryption key for decrypting the encrypted charging record to obtain the user identification data and the encrypted charging data. Subsequently, the CGF applies a remote procedure call to the HSS, with a request to decrypt the encrypted charging data. The decryption request comprises both the user identification data and the encrypted charging data. The HSS contains, for the subscribers who subscribe to this protected charging record transfer feature, the charging data decryption key. Hence, the HSS can decrypt the charging record and return the unencrypted charging data to the CGF. This remote procedure call may take the form of a SOAP/XML request-response or an LDAP query-response, as appropriate.

The request from CGF to HSS, for decrypting a charging record, occurs within a zone referred to as zone B. Information transfer within Zone B, notably the described remote procedure call for charging record decryption, shall be such that the data that is transferred is not readable on intermediate entities. In addition, the data that is transferred shall preferably not be stored on any intermediate entity. It should be noted that the HSS might be an entity in zone C. In that case, there is no zone B.

Once the CGF has received the unencrypted charging data, which might be in the form of a conventional charging record, it is considered that the charging data has arrived in secure zone (Zone C). The CGF will forward the unencrypted charging data, i.e. in readable text, in the form of a conventional charging record via Diameter messages, or other protocol as appropriate, for further processing. The charging record continues to be processed as per prior art, taking the regular safety, security, confidentiality etc. precautions into consideration.

It is described, so far, that the charging data encryption key is administered in HSS and is transferred from HSS to P-CSCF and I-CSCF and decryption is done by means of a query from CGF to HSS (since HSS is the entity where the charging record encryption key is administered). This implies that the HSS has to execute service logic to do the decryption of the charging data (and return the decrypted charging data to CGF).

Said service logic execution, for decrypting the charging data, does not necessarily have to take place in the HSS. It could take place in a functional entity tightly coupled with the HSS. The HSS remains the entity holding the charging data encryption and decryption key. The network entity performing the decryption of the encrypted charging data requests the HSS to supply the charging data decryption key associated with the user identification data in the decryption request from the CGF. The charging data decryption key is in an embodiment used once to decrypt the encrypted charging data. In another embodiment, the charging data decryption key is stored in a data storage of the network entity performing the decryption. In this embodiment the key has to be transmitted once from HSS to the network entity. When encrypted charging data is received, the entity will first look in its data storage for the decryption key based on the user identification data in the request. If the decryption key is not in its data storage it will request the HSS to supply the decryption key associated with the user identification data.

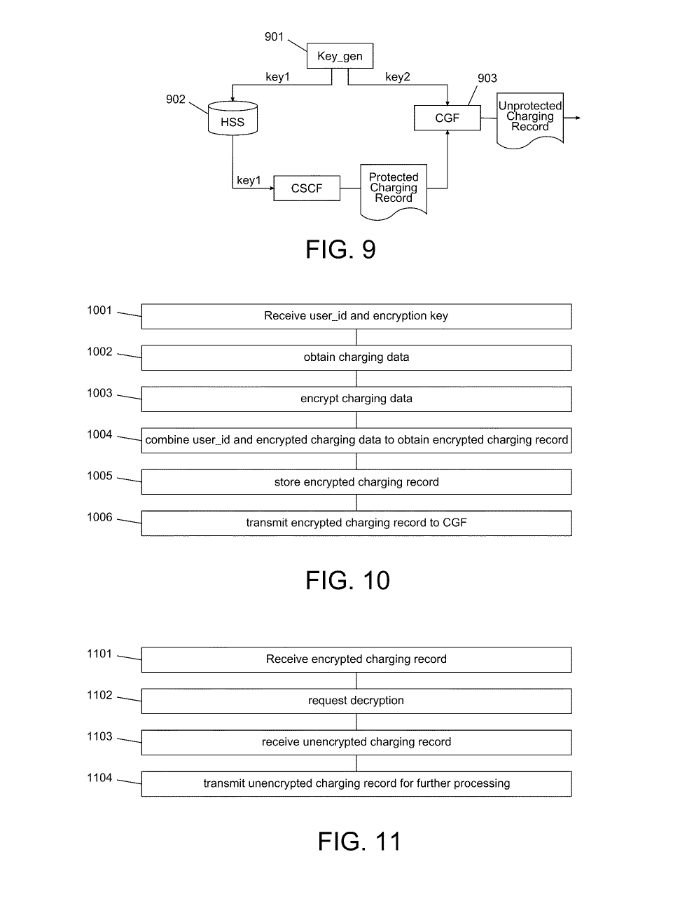

FIG. 9 illustrates a second embodiment of the encryption and decryption of charging records in an IP-based communication service network. In this embodiment a key generating unit 901 generates a charging data encryption key key1 and a charging data decryption key key2. Depending on the used encryption algorithm key1 and key2 are different or similar. The charging data encryption key key1 is supplied to the HSS 902 for storage in its data storage together with the user identification data. The charging data decryption key key2 is supplied to the CGF 903 and stored in its data storage together with the user identification data. This embodiment has the advantage that the encryption key and decryption key of a specific user are stored in different zones of the network. This reduces the risk that personnel having access to the entities generating encrypted charging records could easily obtain the decryption key. The decryption key for a specific subscriber is transferred once over the network to the CGF and subsequently securely stored in its data storage.

The HSS is the distributor of the charging record encryption key through the network (to P-CSCF and I-CSCF) via SIP messages. The CGF is the recipient of the encrypted charging records. The CGF can do the decryption autonomously, without query to the HSS, since it has already the charging data decryption key, which might be a copy of the charging data encryption key.

Provisioning of the secure key into HSS and CGF can be done in a Write-only mode. This is a method applied also for the provisioning of Authentication key in Authentication centre (AuC). When the Authentication key is provisioned into AuC, it is not possible to read it from AuC (through operator command). Likewise, the charging data encryption key or decryption key can be provisioned in HSS and in CGF, but reading the charging data encryption key or decryption key from HSS or charging data decryption key from CGF can be prohibited through operator command.

In a particular network deployment, there may be two or more CGF nodes operational. When charging records for particular subscribers may be received by two or more CGF nodes, then the charging data decryption keys of these subscribers are provisioned into these two or more CGFs (not depicted).

The encryption algorithm may, for example, be the AES-CBC Cipher Algorithm, as described in IETF RFC 3602 [2].

FIG. 10 is a flow diagram illustrating actions that are carried out on a network entity generating charging records. In action 1001, the network entity receives an

IP communication control message comprising user identification data and an associated encryption key. An embodiment of an IP communication message is a SIP signalling message in an IMS-based communication service network. After receipt of the user identification data the network entity is able to generate charging data relating to services used by a subscriber identified by the user identification data. After the network entity has obtained charging data associated with a communications activity related to said user identification data in action 1002, in action 1003 the network entity subjects the charging data to encryption by using the encryption key which is associated with the user identification data. The result of action 1003 is encrypted charging data. Subsequently, the network entity processes the user identification data and the encrypted charging data. The process combines the user identification data and encrypted charging data to obtain an encrypted charging record. Three different processing methods are disclosed in FIGS. 6-8 and corresponding description. In action 1005, the network entity stores the encrypted charging record in a data storage. In action 1006, the network entity transmits the charging record with encrypted charging data to a network entity having the role of charging gateway function (CGF). The transmission could be done periodically or on demand of the CGF.

Depending on the type of network entity, the network entity could also be configured to sending another IP communication control message to another network entity. The another IP communication control message comprising the user identification data and the associated encryption key. For example, the S-CSCF and P-CSCF are configured to receive a SIP message suitable for a first type of use comprising the user identification data and the associated encryption key and to transmit a SIP message suitable for a second type of use comprising the user identification data and the associated encryption key.

FIG. 11 is a flow diagram illustrating actions that are carried out on a network entity having the role of charging gateway function in an IP-based network as disclosed in FIG. 5 and corresponding description. In action 1101, the network entity receives an encrypted charging record comprising user identification data and encrypted charging data. The encrypted charging data has been obtained by subjecting charging data associated with a communications activity related to the user identification data to encryption by using an encryption key which is associated with the user identification data. Actions 1102 and 1103 have to be performed to subject the encrypted charging record to a decryption process to obtain a charging record comprising the user identification data and unencrypted charging data. In action 1102, the network entity transmits a request to a network entity which is configured to perform the decryption process on the encrypted charging data. The request could comprise the original encrypted charging record or a first part comprising the user identification data and a second part comprising the encrypted charging data. In action 1103, the network entity receives the unencrypted charging data and user identification data from the network entity performing the decryption. The result could be in the form of a known charging record format. In that case, action 1104 the network entity forwards the unencrypted charging record for further processing in a way known to the skilled person to a network entity charging the subscribers of the network. In another embodiment, in action 1104 the network entity generates from the data received in action 1103 a charging record in a commonly known format and transmits the charging record for further processing.

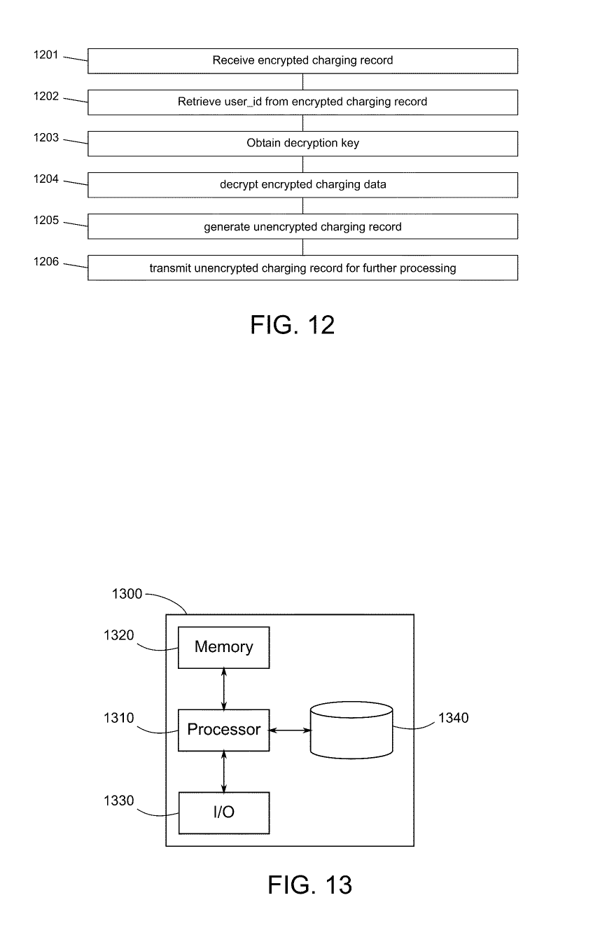

FIG. 12 is a flow diagram illustrating actions that are carried out on a network entity having the role of charging gateway function in an IP-based network and wherein the decryption process is performed in said network entity. In action 1201, the network entity receives an encrypted charging record comprising user identification data and encrypted charging data. The encrypted charging data has been obtained by subjecting charging data associated with a communications activity related to the user identification data to encryption by using an encryption key which is associated with the user identification data. To enable decryption of the encrypted charging data, in action 1202, the network entity retrieves from the encrypted charging record the user identification data. In action 1203, the network entity obtains the charging data decryption key. This could be by accessing its own database which comprises the linkage between user identification data and charging data encryption key. In another embodiment, the network entity requests a subscriber data system, e.g. the HSS, to provide the charging data decryption key associated with the user identification data. The network entity will then receive a charging system provisioning message comprising the user identification data and the associated decryption key. The charging system provisioning message could be in the form of a LDAP message or a CAI-3G message. In action 1204, the network entity performs a decryption process on the encrypted charging data using charging data encryption key associated with the user identification to obtain unencrypted charging data. In action 1205 the network entity combines the user identification data and the unencrypted charging data and generates a charging record comprising the user identification data and unencrypted charging data and having a commonly known format wherein both the user identification data and charging data are in readable text. In action 1206, the network entity transmits the charging record for further processing.

Referring to FIG. 13, there is illustrated a block diagram of exemplary components of a processing unit 1300 of network entities shown in FIG. 1. The processing unit 1300 can be any piece of equipment inside a node or server of a network on which the functionality of a network entity described in the present application is implemented. The processing unit could be a processor board. As illustrated in FIG. 13, the processing unit 1300 comprises a processor 1310, data storage 1320, an Input/Output unit 1330 and a database 1340. The data storage 1320, which could be any suitable memory to store data, comprises instructions that, when executed by the processor 1310 cause the processing unit 1300 to perform the actions corresponding to any of the methods described before. The I/O unit 1330 is configured to provide an Ethernet connection and comprises one hardware address in the form of a MAC address. The I/O unit allows hosts hosted on the processing unit to communicate with other hosts on other processing units in the network. In case the network entity generates charging records, the database 1340 is configured to store the relationship between user identification data and the charging data encryption key associated with the user identification data. The database could further be used to store temporarily the encrypted charging records prior to submission to the network entity acting as CGF. In case the network entity acts as CGF and performs internally the decryption, the database 1340 is configured to store the relationship between user identification data and the charging data decryption key associated with the user identification data.

The invention is targeting the safeguarding of charging data stored in charging records, produced by various entities in the network, so long as these charging records have not been transferred to the CGF. The invention is particularly useful for entities that keep charging records within the system (on disk) and transfer the charging record at regular interval or provide access to the charging records by external systems, for retrieving the charging records from that system.

Not all entities keep charging records, by default, in their own storage, but instead send the charging record immediately towards the CGF. For those entities, the applicability of the invention is less, since the charging records have limited life time in these systems.

The method described above is also suitable for split charging and reverse charging. The encryption of the charging data will be based on the subscriber initiating a communication session. When charging of a communication session deviates from a regular charging method, e.g. a call from A-party to B-party is charged against the B-party, than the charging record(s) shall contain a corresponding indication. More specifically, the charging record indicates the party/parties against whom the call shall be charged. However, in all cases the charging record is generated by a network entity allocated for the calling party (A-party). Furthermore, a field of the generated charging record identifies the calling party by means of user identification data of A-party. As the network entity also has received the charging data encryption key during allocation for A-party, the network entity uses said encryption key to encrypt the charging data. The encrypted charging record is transmitted to the CGF. The CGF uses subsequently the user identification data of the calling party to decrypt the charging data and to forward a charging record with data indicating the charging method and the unencrypted charging data for further processing. Rationale is that even though the B-party pays for a call, the charging record is still directly related to the call from the A party.

However, with the increase of application servers generating charging records, the invention does provide a safe principle method of storing and transferring charging records, up to CGF.

The P-charging-function-addresses (PCFA) header is not conveyed between different IMS operators, such as in IMS roaming situation. Hence, for IMS roaming situation, the charging record encryption key is not conveyed to the roaming partner's network. However, the person skilled in the art will appreciate that the visited network operator may implement a similar mechanism as defined for the home IMS network. For example, the Interconnection Border Control Function (IBCF) located at the border of the roaming partner's IMS network may assign a charging record encryption key and depending on the applied encryption method a charging record decryption key and assign the key(s) to the inbound roaming subscriber. The IMPU/IMPU is visible from the SIP signalling that traverses the IBCF. Hence, the IBCF may keep record of inbound roaming IMPU/IMPI and assigned charging record encryption/decryption key. The charging record encryption key is then transferred from IBCF to P-CSCF, in the PCFA header as previously described. The CGF in the foreign IMS network has access to said database (containing inbound roaming IMPU/IMPI and assigned charging record encryption/decryption key) and can hence decrypt the encrypted charging records.

In the case of IMS roaming registration, the S-CSCF shall not transfer the charging record encryption key on towards P-CSCF. Instead, the S-CSCF shall keep the charging record encryption key in its own record of subscriber data. The S-CSCF has, in that manner, the charging record encryption key available in the case of initial SIP request from the roaming subscriber.

The present application provides a secure method of transferring charging data through an IMS based communication system. Charging records are encrypted by the network entity that generates the charging record. Encryption is based on a subscriber-specific charging data encryption key, which is stored in HSS and securely transferred to the respective entities in the IMS network that generate charging records.

Encrypted charging records are received by the network entity acting as CGF and are decrypted by the CGF, or by an entity external to CGF, where they are assumed to be in a safe area.

The encryption of charging records does not have to be applied to IMS communication of all subscribers. It may be applied to selected subscribers only. When a subscriber is not provisioned with a charging data encryption key in the HSS, the charging records for communication sessions for this subscriber are stored and transferred according to prior art.

The advantages of this method include:
charging records are considered to be confidential data and, for at least a selected group of subscribers, security-related information. Consider e.g. army officials above certain rank. The method of the invention prohibits reading the charging data by unauthorized personnel,
the charging data can't be modified, since that would break the encryption key based encoding. The entity processing the encrypted charging records, i.e. the CGF, would determine that the charging record has been tampered with and can raise an alarm.

An IMS based communication service network is used to illustrate the method of handling charging data in an IP-based network. It will be clear for the skilled person that the method could also be implemented in other IP-based communication network wherein charging records are generated in one network entity and processed in another network entity to charge a subscriber.

The present invention and its exemplary embodiment can be realized in many ways. For example, one embodiment includes a computer-readable medium or a computer program product having computer readable code stored thereon that are executable by a processor of a piece of equipment inside a node of a private network, such as a processor board, to perform the method of the exemplary embodiments as previously described.

While the invention has been described in terms of several embodiments, it is contemplated that alternatives, modifications, permutations and equivalents thereof will become apparent to those skilled in the art upon reading the specification and upon study of the drawings. The invention is not limited to the illustrated embodiments. Changes can be made without departing from the idea of the invention.

1. A method of handling charging data in a network entity of an IP-based network; the method comprising:
receiving an IP communication control message comprising user identification data and an associated encryption key;
obtaining charging data associated with a communications activity related to said user identification data;
subjecting the charging data to encryption by using the encryption key that is associated with the user identification data to obtain encrypted charging data;
processing the user identification data and the encrypted charging data to obtain a charging record with encrypted charging data; and
transmitting the charging record with encrypted charging data to a network entity having the role of charging gateway function.

2. The method according to claim 1, wherein processing the user identification data and the encrypted charging data includes encrypting the user identification data using a network encryption key.

3. The method according to claim 1, wherein processing the user identification data and the encrypted charging data further includes encrypting the user identification data and the encrypted charging data using a network encryption key.

4. The method according to claim 1, the method further comprising:
sending another IP communication control message to another network entity, the another IP communication control message comprising the user identification data and the associated encryption key.

5. The method according to any of the claim 1, the method further comprising:
storing the encrypted charging record in a data storage prior to transmission.

6. The method according to claim 1, wherein the IP-based network is an IMS network and the IP communication control messages are SIP messages.

7. A method of handling charging data in a network entity having the role of charging gateway function of an IP-based network; the method comprising:
receiving a charging record comprising user identification data and encrypted charging data, the encrypted charging data has been obtained by encrypting charging data associated with a communications activity related to the user identification data by using an encryption key which is associated with the user identification data; and
subjecting the charging record comprising user identification data and encrypted charging data to a decryption process to obtain a charging record comprising the user identification data and unencrypted charging data.

8. The method according to claim 7, wherein the subjecting comprises:
transmitting the charging record comprising the user identification data and the encrypted charging data to a network entity performing the decryption process; and
receiving the charging record comprising the user identification data and unencrypted charging data from the network entity performing the decryption process.

9. The method according to claim 7, the method further comprising:
receiving a charging system provisioning message comprising user identification data and an associated decryption key; and
the subjecting comprises:
decrypting the encrypted charging data by using the decryption key associated with the user identification data to obtain the unencrypted charging data; and
combining the user identification data and the unencrypted charging data to obtain the charging record comprising the user identification data and unencrypted charging data.

10. The method according to claim 9, wherein the decryption key associated with the user identification data differs from the encryption key associated with the user identification data.

11. The method according to claim 7, wherein the IP-based network is an IMS network and the charging system provisioning message is one of an LDAP message and a CAI-3G message.

12. A processing device comprising a processor, an Input/Output device to connect to an IP-based network, a database and a data storage comprising instructions, which when executed by the processor, cause the processing device to:
receive an IP communication control message comprising user identification data and an associated encryption key and store the user identification data and associated encryption key in the database;
obtain charging data associated with a communication activity related to said user identification data;
subject the charging data to encryption by using an encryption key which is associated with the user identification data to obtain encrypted charging data;
process the user identification data and the encrypted charging data to obtain a charging record with encrypted charging data; and
transmit the charging record with encrypted charging data to a network entity having the role of a charging gateway function.

13. The processing device according to claim 12, wherein processing the user identification data and encrypted data includes encrypting the user identification data using a network encryption key.

14. The processing device according to claim 12, wherein processing the user identification data and encrypted data includes encrypting the user identification data and the encrypted charging data using a network encryption key.

15. A processing device comprising a processor, an Input/Output device to connect to an IP-based network, a database and a data storage comprising instructions, which when executed by the processor, cause the processing device to:
receive a charging record comprising user identification data and encrypted charging data, the encrypted charging data has been obtained by encrypting charging data associated with a communication activity related to the user identification data by using an encryption key which is associated with the user identification data; and
subject the charging record comprising the user identification data and the encrypted charging data to a decryption process to obtain a charging record with the user identification data and unencrypted charging data.

16. The processing device according to claim 15, wherein the instructions, which when executed by the processor, further cause the processing device to:
receive a charging system provisioning message comprising user identification data and an associated decryption key; and
the subjecting comprises:
decrypting the encrypted charging data by using the decryption key associated with the user identification data to obtain unencrypted charging data; and
combining the user identification data and the unencrypted charging data to obtain the charging record with the user identification data and unencrypted charging data.

17. The method according to claim 2, further comprising sending another IP communication control message to another network entity, the another IP communication control message comprising the user identification data and the associated encryption key.

18. The method according to claim 3, further comprising sending another IP communication control message to another network entity, the another IP communication control message comprising the user identification data and the associated encryption key.

19. The method according to claim 2, further comprising storing the encrypted charging record in a data storage prior to transmission.

20. The method according to claim 8, wherein the IP-based network is an IMS network and the charging system provisioning message is one of an LDAP message and a CAI-3G message.
